(19) United States
(12) Patent Application Publication
(10) Pub. No.: US 2012/0323725 A1
(43) Pub. Date: Dec. 20, 2012

(54) SYSTEMS AND METHODS FOR SUPPLEMENTING CONTENT-BASED ATTRIBUTES WITH COLLABORATIVE RATING ATTRIBUTES FOR RECOMMENDING OR FILTERING ITEMS

(75) Inventors: Jeffrey W. JOHNSTON, Charlottesville, VA (US); Louis P. Slothouber, Leesburg, VA (US)

(73) Assignee: FourthWall Media, Dulles, VA (US)

(21) Appl. No.: 13/325,717

(22) Filed: Dec. 14, 2011

Related U.S. Application Data
(60) Provisional application No. 61/423,241, filed on Dec. 15, 2010.

(51) Int. Cl. G06Q 30/00

(52) U.S. Cl. 705/26.7

(57) ABSTRACT

Disclosed herein are systems and methods for supplementing content-based attributes with collaborative rating attributes for recommending or filtering items. Collaborative rating data may be consolidated into “composite critics” which serve as item quality rating attributes. These attributes may be used in conjunction with content-based attributes to generate user preference models. Composite critics may be formed using data clustering methods such that users with similar tastes may be grouped together. The user preference models may be induced using machine learning processes, such as decision trees, artificial neural networks, support vector machines, and/or statistical techniques. In some embodiments, composite critics may represent a small number of users or professional critics selected for having differing sensibilities and who rate most or all items according to those sensibilities.

### CROSS-REFERENCE TO RELATED APPLICATIONS

This application claims priority to U.S. Provisional Patent Application No. 61/423,241, filed Dec. 15, 2010, which is hereby incorporated by reference in its entirety.

### FIELD OF THE INVENTION

In general, the invention relates to artificial intelligence and data processing. More specifically, the invention relates to systems and methods for supplementing content-based attributes with collaborative rating attributes for recommending or filtering items.

### BACKGROUND INFORMATION

Systems that automatically suggest items of potential interest or filter out items of disinterest are becoming increasingly important because people must frequently decide which items to consume while faced with a staggering number of choices and options. For example, a person may need to choose between television programs, movies, music, books, news stories, documents, products, services, e-mails, advertisements, and/or many other various items.

Accordingly, as consumer options continue to increase, making personal recommendations or filtering out undesirable options may simplify consumer transactions by helping people make these choices based their interests. Recommendation and filtering systems have been developed which take content-based, collaborative filtering, and hybrid approaches. However, current systems may lack an effective approach that allows collaborative item rating data to supplement content-based item data for recommending or filtering items, particularly in ways that leverage content-based recommendation and filtering techniques.

There is a need for an item recommendation or filtering system and method that is conceptually simple, has tractable processing characteristics, avoids the need for ad hoc engineering of collaborative features, is easy to integrate in content-based frameworks, and may improve content based recommendations by taking advantage of item quality data available from collaborative-filtering data or other “review” sources.

### SUMMARY OF EXEMPLARY EMBODIMENTS

The present invention may satisfy the aforementioned needs by providing systems and methods for supplementing content-based attributes with collaborative rating attributes for recommending or filtering items.

In some embodiments, the present invention may provide systems and methods for recommending or filtering items by obtaining item interest data from users; clustering the users into groups of users based on the interest data; generating composite rating attribute values for each item where each attribute value represents an aggregation of the interest data for the item for one or more of the groups of users; creating one or more user preference models using the composite rating attribute values in conjunction with content-based attributes; and recommending items to users or filtering items from users based on the user preference models.

In some embodiments, the items being recommended or filtered include television programs, movies, music, books, documents, products, services, e-mails, and advertisements.

In some embodiments, the item interest data are represented as binary preference values and/or a multi-valued range of ratings.

In some embodiments, obtaining item interest data from users comprises obtaining data from multiple users whose item interest data are gathered over time via a rating system. The item interest data may be gathered implicitly, explicitly, or both.

In some embodiments, obtaining item interest data from users comprises obtaining item interest data from users selected for having differing sensibilities, wherein these users represent de facto groups of users.

In some embodiments, the clustering of users into groups utilizes a hierarchical or partitional clustering technique based on an assessment of similarity of ratings between users, where each user is clustered into a unique group. In other embodiments, users may be clustered into multiple groups (e.g., fuzzy clustering).

In some embodiments, generating a composite rating attribute value comprises averaging interest values of all the users in a given group and substituting a special value for those items having zero or a small number of ratings. The special value may be one or more of: (a) the global average interest value of all items in the user group, (b) the global average interest value of all items in the user group for items having zero ratings and the global average interest value averaged with the existing item ratings for items having one or more ratings, (c) the average of the lowest quartile of values for items over the entire group, and/or (d) a value generated by an induction process using content-based attributes alone wherein the average interest values for each item rated by users are used as target independent variables and content-based attributes are used as dependent variables during a training phase, and the resulting user preference model is used to valuate the special value.

In some embodiments, in addition to composite rating attribute values being generated, attributes are generated indicating: the total number of raters used to generate each composite rating attribute value for each item in each group, and the distribution of ratings used to generate each composite rating attribute value for each item in each group.

In some embodiments, creating user preference models utilizes at least one of a decision tree, artificial neural network, support vector machine, regression tree, decision tree with linear models in leaves, machine learning induction mechanism, and statistical process.

In some embodiments, the recommending or filtering of items comprises submitting vectors for new items having composite rating attribute values and content attribute values to the previously-generated user model, and receiving a classification value or predicted rating as output.

In some embodiments, a system and method for recommending or filtering items may be provided. The system and method may comprise obtaining item interest data from users. The system and method may comprise clustering the users into groups of users based on the interest data. The system and method may comprise generating composite rating attribute values for each item, wherein each attribute value represents an aggregation of the interest data for the item for one or more of the groups of users. The system and method may comprise creating one or more user preference models using the composite rating attribute values in conjunction with content-based attributes. The system and method may also comprise at least one of recommending items to users and filtering items from users based on the user preference models.

In some embodiments, the items may be at least one of television programs, movies, music, books, documents, products, services, e-mails, and advertisements. In some embodiments, the item interest data may be represented as binary preference values. In some embodiments, the item interest data may be represented as a multi-valued range of ratings.

In some embodiments, obtaining item interest data may comprise obtaining data from a plurality of users whose item interest data are gathered over time via a rating system, wherein the item interest data are gathered implicitly, explicitly, or a combination thereof. In some embodiments, obtaining item interest data may comprise obtaining item interest data from users selected for having differing sensibilities, wherein these users serve as de facto groups of users.

In some embodiments, clustering the users into groups may comprise at least one of a hierarchical and partitional process based on an assessment of similarity of ratings between users. It should be appreciated that the similarity may be calculated as: rₐdₛ where r_{xy} is the correlation coefficient,

$$\frac{s \sum {x}_{i} {y}_{i} - \sum {x}_{i} \sum {y}_{i}}{\sqrt{s \sum {x}_{i}^{2} - {( \sum {x}_{i} )}^{2}} \sqrt{s \sum {y}_{i}^{2} - {( \sum {y}_{i} )}^{2}}} ,$$

and dₛ is a logistic function de-rating factor, a((1+me^{-s/τ})/(1+ne^{-s/τ})), where s is the number of items rated by both user x and user y, xᵢ and yᵢ are the rating values for shared item i, sums are over i=1 to s, and a, m, n, and τ are constants.

In some embodiments, clustering the users into groups may be fuzzy such that a user may be included in multiple groups.

In some embodiments, generating a composite rating attribute value may comprise averaging interest values of all the users in a given group and substituting a special value for those items having zero or a small number of ratings. It should be appreciated that the special value may be the global average interest value of all items in the group. In some embodiments, the special value may be at least one of: the global average interest value of all items in the user group for items having zero ratings, and the global average interest value averaged in with the existing item ratings for items having one or more ratings. In some embodiments, the special value may be equal to the average of the lowest quartile of values for items over the entire group. In some embodiments, the special value may be generated by an induction process using content-based attributes alone wherein the average interest values for each item rated by users are used as target independent variables and content-based attributes are used as dependent variables during a training phase, and the resulting user preference model is used to valuate the special value.

In some embodiments, generating composite rating attribute values may further comprise generating additional attributes that indicate at least one of: the total number of raters used to generate each composite rating attribute value for each item in each group, and the distribution of ratings used to generate each composite rating attribute value for each item in each group.

In some embodiments, creating user preference models may utilize at least one of a decision tree, artificial neural network, support vector machine, regression tree, decision tree with linear models in leaves, machine learning induction mechanism, and statistical process.

In some embodiments, the at least one of recommending and filtering may comprise: submitting vectors for new items having composite rating attribute values and content attribute values to the previously-generated user model, and receiving a classification value or predicted rating as output.

### BRIEF DESCRIPTION OF DRAWINGS

FIG. 1 depicts of a block diagram of a system architecture for providing personal recommendations using content-based and collaborative information, according an exemplary embodiment of the present invention.

FIG. 2 depicts a flowchart of a method for generating a composite critic, according an embodiment of the present invention.

### DETAILED DESCRIPTION OF EMBODIMENTS

Reference will now be made in detail to exemplary embodiments, examples of which are illustrated in the accompanying drawings. It should be appreciated that the same reference numbers will be used throughout the drawings to refer to the same or like parts. It should be appreciated that the following detailed description are exemplary and explanatory only and are not restrictive. For example, the following description is intended to convey an understanding of the invention by providing a number of specific embodiments and details involving various applications of the invention. It should be further appreciated that various alternative embodiments may also be realized, depending upon specific design and other needs.

Recommending or filtering items may be accomplished in several ways. One popular class of methods are content-based. In such methods, content and/or other characteristics of items themselves may be used to gauge a user or person's interests. For example, in a movie recommender, information related to the movie (e.g., genres, actors, producers, writers, MPAA advisories, production date, etc.) may be used to predict other movies of interest for the person. Items with content similar to the content of items previously rated highly by the user may be recommended to the user.

In another class of methods, recommendations may be based on collaborative filtering, in which interests of a user are predicted based on the interests of other users. For example, by identifying groups of like-minded people or groups of similar items (e.g., based on the interest ratings of a predefined population, etc.), recommendations may be generated and offered to a user or person within that identified group.

In yet another class of methods, aspects of content-based and collaborative filtering methods may be combined. These hybrid methods may attempt to optimize the respective strengths and reduce the weaknesses of each approach. For example, content-based methods may suffer from difficulty defining and extracting features, new user ramp-up, or lack of variety in recommendations. Collaborative filtering methods may be limited by sparse ratings (e.g., first rater, first item, recommending less popular items, etc.), “gray sheep” (e.g., users whose tastes differ too much from other users), and spoofing (e.g., artificially raising or lowering an item's rating).

Some hybrid recommenders may be loosely integrated so that content-based and collaborative filtering approaches operate independently (or nearly independently) of each other and recommendations from multiple approaches may be combined via voting, weighting, heuristics, and/or other similar recommendation approaches. The need to run multiple loosely-integrated methods may adversely impact performance, cost, usability, reliability, and other aspects of such systems.

Other hybrid recommenders may integrate content-based and collaborative filtering more tightly. For example, hybrid recommendations may be provided using Bayesian models that utilize all (or almost all) available item and/or rating data. Hybrid recommendations may also be provided by augmenting collaborative filtering rating matrices via generating artificial users and/or estimating values for missing ratings. These approaches may integrate well with collaborative filtering-based systems but may be incompatible with content-based approaches. They also may be somewhat ad hoc and may suffer from performance problems when scaled to handle many users and items.

A content-based based approach to providing recommendations is provided in U.S. application Ser. No. 11/465,967 to Slothouber et al. (“Slothhouber”), which is hereby incorporated by reference in its entirety. Slothouber's approach may define some quality-related attributes associated with each item provided by professional critics or other reviewers (e.g., QUALITY STINKS, QUALITY WATCHABLE, QUALITY WONDERFUL, etc.). However, these quality attributes may be limited to a small number of predefined attributes gleaned from authoritative sources. It is not disclosed therein how collaborative filtering data or quality data from other sources may be leveraged to improve content-based recommendations.

According to the present invention, a hybrid system and method for supplementing content-based attributes with collaborative rating attributes for recommending or filtering items may be provided which may offer a comprehensive and balanced approach that may be conceptually simple, may have tractable processing characteristics, may avoid the need for ad hoc engineering of collaborative features, may be easy to integrate in content-based frameworks, and/or may improve content based recommendations by taking advantage of item quality data available from collaborative-filtering data or other “review” sources.

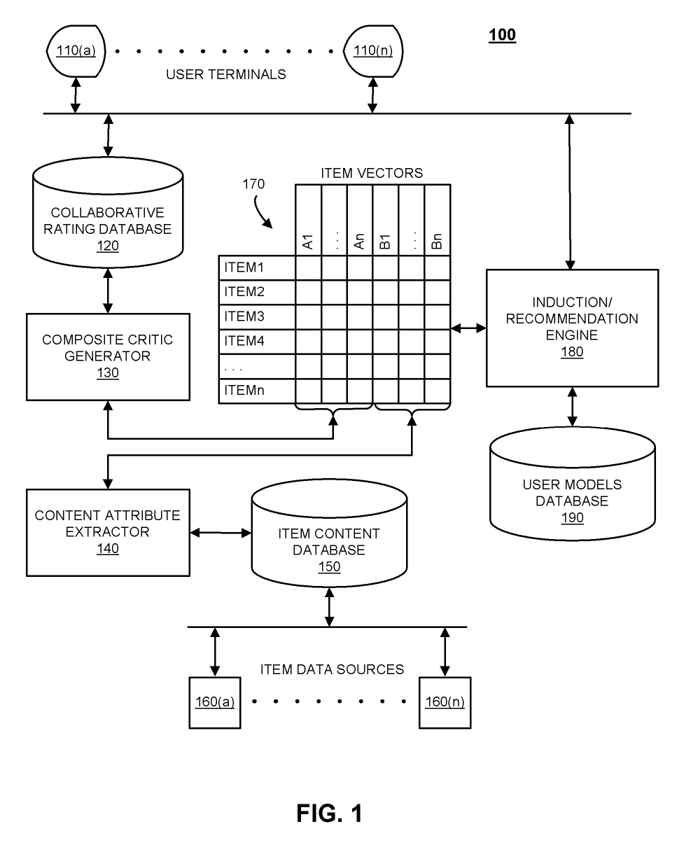

FIG. 1 depicts a block diagram of a system architecture for providing personal recommendations using content-based and collaborative information, according an exemplary embodiment of the present invention. It should be appreciated that filtering items of disinterest is closely related to providing personal recommendations. Filtering may involve the automatic removal or hiding of items predicted as being not of interest to a user, whereas providing personal recommendations may involve the automatic presentation of items predicted as being of interest to a user. The underlying mechanisms may be essentially identical. In the following descriptions, reference is generally made to providing personal recommendations for sake of clarity. It should also be appreciated that system 100 is a simplified view for providing personal recommendations and may include additional elements that are not depicted. As illustrated, the system 100 may be a hybrid recommender system that utilizes content-based and collaborative information. The system 100 may include user terminals 110(a)-110(n), a collaborative rating database 120, a composite critic generator 130, a content attribute extractor 140, and an item content database 150, which are connected to one or more item data sources 160(a)-160(n). The composite critic generator 130 and the content attribute extractor 140 may generate item vectors 170, which may be used by an induction/recommendation engine 180. The induction/recommendation engine 180 may be coupled to a user models database 190. The induction/recommendation engine 180 may also be communicatively coupled to the user terminals 110(a)-110(n).

Each user terminal 110(a)-110(n) may be a communications system and/or device. For example, these may include desktop computers, laptops/notebooks, tablet computers, servers or server-like systems, modules, Personal Digital Assistants (PDAs), smart phones, cellular phones, mobile phones, satellite phones, MP3 players, video players, personal media players, set-top boxes, personal video recorders (PVR), watches, gaming consoles/devices, navigation devices, televisions, printers, and/or other devices capable of receiving and/or transmitting signals. It should also be appreciated that each user terminal 110(a)-110(n) may be mobile, handheld, or stationary. It should also be appreciated that each user terminal 110(a)-110(n) may be used independently or may be used as an integrated component in another device and/or system.

In one embodiment, the one or more item data sources 160(a)-160(n) may be accessed for data describing items (e.g., products, movies, etc.) and the data collected, cleansed, reformatted, and/or saved in an item content database 150. The item content data may be processed by the content attribute extractor 140. For example, the content attribute extractor 140 may valuate attributes descriptive of each item (e.g., attributes B1-Bn), which may be represented in one or more item vectors 170. Examples of movie content attributes (B1-Bn) which may be extracted by the content attribute extractor 140 include attributes relating to genres, subgenres, actors, producers, writers, MPAA-type advisories, production date, mood, etc. In a movie recommender, for example, such content attributes may be extracted from a variety of sources that provide movie information (e.g., Internet Movie Database (IMDb), Netflix, movies.com.). Accordingly, these item vectors 170 may then used by an induction/recommendation engine 180 to build one or more user models descriptive of each user's likes and/or dislikes. In one embodiment, these user models may be stored in a user models database 190 and may be used to make recommendations of new items to users at the one or more user terminals 110(a)-110(n). Other various embodiments may also be realized.

Item interest data (e.g., collaborative rating data) may be collected and stored in the collaborative rating database 120 from one or more users at one or more user terminals 110(a)-110(n) of the system 100. The composite critic generator 130 may cluster users into groups of like-minded users and generate composite rating attribute values for each item in each group by aggregating the user interest data from the users in each group. The induction/recommendation engine 180 may create user models using the composite rating attributes (attributes A1-An) in conjunction with content-based attributes (attributes B1-Bn) for each item vector (ITEM1-ITEMn) 170. In this example, one or more user models descriptive of each user's likes and/or dislikes (e.g., based on content and collaborative filtering) may be stored in the user models database 190 and may be used to make recommendations of new items to users at the one or more user terminals 110(a)-110(n).

It should be appreciated that while embodiments above are directed to movie recommendations, other types of recommendations may also be provided. For example, these may include television programs, videos, music, books, documents, products, services, e-mail, advertisements, artwork, etc.

It should be appreciated that item interest data contained in the collaborative rating database 120 may be obtained from a plurality of users connected via user terminals 110(a)-110(n) to a collaborative-filtering, social networking, or other rating system. For example, item interest data may be gathered implicitly via monitoring user actions (e.g., clickstream data, keyword searches, browsing history, etc.) and/or explicitly via soliciting user ratings (e.g., selecting on thumbs-up/thumbs-down, stars, numbers, and/or other ratings actions) at the user terminals 110(a)-110(n). Other various embodiments may also be provided.

It should also be appreciated that item interest data contained in the collaborative rating database 120 may be obtained from users selected for having differing sensibilities and who rate items according to those sensibilities. In this situation, such users may be professional critics and/or others hired to rate items and may serve as “de facto” groups of users. Such user-critics may be selected for having sensibilities conforming to different segments in a market segmentation system or other similar categorization. For example, these may include Simmons BehaviorGraphics, Claritas Prism-NE, Acxiom PersonicX, and/or other similar system. Such critics may be closely representative of a centroid or exemplar of their respective segments. In other embodiments, critics may be various people with differing sensibilities but not conforming to any formal segmentation system. Other various embodiment may also be realized. It should also be appreciated that item interest data contained in the collaborative rating database 120 may be represented as binary preference values (e.g., liked/disliked, 1/0), a multi-valued range of ratings (e.g., 1-5 stars, −128 to +128, or real values), and/or other similar valuation or weighting model.

It should be appreciated that each of the components of the system 100 may be configured to receive, transmit, and/or process signals/data. For example, each of servers, server-like systems, devices, modules, databases, sources, and/or terminals may have one or more receivers, one or more transmitters, and/or one or more processors in order to communicate (e.g., receive, process, and/or transmit data/information) with the other components of system 100. Communications may be achieved via transmission of electric, electromagnetic, optical, or wireless signals and/or packets that carry digital data streams using a standard telecommunications protocol and/or a standard networking protocol. These may include Session Initiation Protocol (SIP), Voice Over IP (VOIP) protocols, Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols. Other protocols and/or systems that are suitable for transmitting and/or receiving data via packets/signals may also be provided. For example, cabled network or telecom connections such as an Ethernet RJ45/Category 5 Ethernet connection, a fiber connection, a traditional phone wireline connection, a cable connection or other wired network connection may also be used. Communication between the network providers and/or subscribers may also use standard wireless protocols including IEEE 802.11a, 802.11b, 802.11g, etc., or via protocols for a wired connection, such as an IEEE Ethernet 802.3.

It should be appreciated that communications between components of system 100 may be conducted over at least one network (not shown), such as a local area network (LAN), a wide area network (WAN), a service provider network, the Internet, or other similar network. It should be appreciated that the network may use electric, electromagnetic, and/or optical signals that carry digital data streams.

It should also be appreciated that the components of system 100 may be used independently or may be used as an integrated component in another device and/or system. It should also be appreciated that even though the components of system 100 are shown as separate components, these may be combined into greater or lesser components to optimize flexibility. The components of system 100 may also be local, remote, or a combination thereof to each other or other system components. Other various embodiments may also be realized.

While depicted as components, servers, server-like systems, devices, modules, databases, sources, and/or terminals of the system 100, it should be appreciated that embodiments may be constructed in software and/or hardware, as separate and/or stand-alone, or as part of an integrated transmission and/or switching device/networks. For example, it should also be appreciated that the one or more network components, servers, server-like systems, devices, modules, databases, sources, and/or terminals of the system 100 may not be limited to physical components. These components may be software-based, virtual, etc. Moreover, the various components, servers, modules, and/or devices may be customized to perform one or more additional features and functionalities. Also, although depicted as singular network or system components, each of the various networks or system components may be equal, greater, or lesser.

Additionally, it should also be appreciated that support and updating of the various components of the system 100 may be easily achieved. For example, an administrator may have access to one or more of these networks or system components. Such features and functionalities may be provided via deployment, transmitting and/or installing software/hardware.

It should also be appreciated that each of the system components may include one or more processors, servers, server-like systems, devices, modules, and/or databases for providing recommendations. Although several databases are shown, It should be appreciated that one or more data databases may also be coupled to each of the one or more processors, servers, modules, and/or devices of the system 100 to store relevant information for each of the servers and system components. Other various embodiments may also be provided. The contents of any of these one or more data storage systems may be combined into fewer or greater number of data storage systems and may be stored on one or more data storage systems and/or servers. Furthermore, the data storage systems may be local, remote, or a combination thereof to clients systems, servers, and/or other system components. In another embodiment, information stored in the databases may be useful in providing additional customizations for optimizing personal recommendations. Other various embodiments and variations may also be realized.

By using the system 100 as described above, quality of user models and accuracy of item recommendations may be increased by using both content and collaborative data when available. Additionally, system 100 may provide a straightforward way to improve content-based systems by adding attributes derived from collaborative data, which allows content-based learning techniques to be easily leveraged to build user models. Moreover, preparation of the attribute values derived from collaborative data may be accomplished in a straightforward front-end process.

Embodiments of the present invention may be instructively characterized, for example, as a content-based recommender supplemented by critic/collaborative ratings. The system 100 may extend the concept of quality ratings by describing methods for (a) systematically including a plurality of quality-related attributes into vectors descriptive of items, and (b) automatically generating such quality-related attributes using collaborative data.

In application, for example, collaborative ratings may be provided by one or more critic(s) for a number of available items. For instance, in a TV or movie recommender, there may be attributes representing various rating types or styles. These may include IMDb and/or Netflix consensus user ratings, TV Guide and/or Tribune Media Services Zap2it 1-4 star ratings, and/or other ratings by professional critics and/or TV/movie web sites or publications (e.g., Roger Ebert, Rolling Stone, metacritic.com, rottentomatoes.com). Thus, in addition to having attributes for genre, advisories, production date, artists, cost, air time, and/or other similar attributes, one or more attributes may be provided to codify item quality. These attributes may be processed together using the composite critic generator 130, content attribute extractor 140, and induction/recommendation engine 180 in an embodiment of the present system using machine learning, statistical, and/or probabilistic processes to generate user models and make recommendations. In such a configuration, item-quality attributes may be treated as just another type of attribute descriptive of the item.

It should be appreciated that machine learning, statistical, and/or probabilistic processes for generating user models may include decision trees, artificial neural networks, support vector machines, regression trees, decision trees with linear models in leaves, Bayesian networks, statistical models, probabilistic models, and/or similar techniques.

It should also be appreciated that item quality attributes may be highly predictive of a user's interests in items. For example, a newly released movie may be classified in the science fiction genre, star a renowned actor, and be directed by a respected director. From these attributes, one might expect most Sci-Fi movie enthusiasts would enjoy the film. However, if the movie was poorly written, badly acted, shoddily produced, or had other shortcomings, Sci-Fi enthusiasts may very well dislike it. Accordingly, in this case, negative critic ratings may outweigh the significance of the positive content-based attributes and correctly classify the movie as one to avoid.

Similarly, rather than relying on collaborative filtering alone to represent item quality and content and generate recommendations, the system 100 may utilize collaborative data to represent quality of items while also utilizing content-based attributes to provide further discrimination and/or more personalized models of individual users. This may also help overcome well-known weaknesses of collaborative filtering such as those mentioned earlier.

In another embodiment, by including an assortment of critics, individual users may be more likely to correlate with one or more critic(s) as predictive of their likes and dislikes. For example, if there are attributes representing item ratings by three critics (e.g., A, B, and C), each with different sensibilities, a decision tree induction engine may learn sophisticated rules to pinpoint user preferences. For instance, Bob (a user) may generally agree with Critic A's rating except when it comes to romantic comedies. In those cases, Bob may tend to agree with Critic B. Alternatively, Bob may find his opinion of movies to be opposite that of Critic C (e.g., a movie that C rates as “bad” Bob may tend to like). Also, Bob may generally dislike R-rated movies, except for those that are highly rated by Critic A. In such scenarios, the potential benefit of using multiple, distinct quality and content attributes together may be apparent by providing better personal recommendations to Bob.

We have found that when using decision or regression trees as the induction/recommendation engine 180, composite critic attributes appear prominently in the resulting rules constituting the user models 190. Thus, composite critics may serve as high-gain attributes effective for building user models in conjunction with content-based attributes.

It should be appreciated that various ways of generating item-quality attributes may be provided. Also, it should be appreciated that composite critics may be real critics or composites of ratings gathered from a community of users. In the event that critics are composited from collaborative filtering data, composite critic rating values may be automatically generated. In one embodiment, compositing may be initiated via agglomerative and/or partitional clustering, whereby like-minded users may be grouped into segments based on rating similarities. Key considerations for generating effective clusters may include: (a) defining a suitable measure of user-to-user similarity; (b) finding a sufficient number of clusters of like-minded individuals that correlate well to most individual users; and/or (c) assuring there are a sufficient number of user-rating data points in each cluster to provide robust aggregate rating values for most items. These embodiments, particularly (b) and (c), may present a fundamental tradeoff to be balanced during implementation.

Once clustered, various techniques of averaging with missing-value replacement and/or blending may be employed for generating composite critic rating values for each item.

In addition to composite rating attributes, other attributes may be generated from the collaborative data. These may include, for example, attributes indicating the total number of raters or attributes indicating the distribution of ratings applicable to each item in each group. Such attributes may be useful in the final induction stage for generating rules like: “Bob likes items that are rated favorably by Critic B when there were a large number of ratings used to generate the rating and the distribution was bi-modal.”

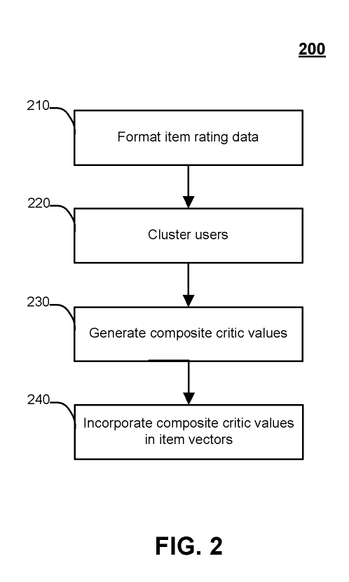

FIG. 2 depicts a flowchart of a method for generating a composite critic, according an embodiment of the present invention. The exemplary method 200 is provided by way of example, as there are a variety of ways to carry out methods disclosed herein. The method 200 shown in FIG. 2 may be executed or otherwise performed by one or a combination of various systems. The method 200 is described below as carried out by at least system 100 in FIG. 1, by way of example, and various elements of systems 100 are referenced in explaining the example method of FIG. 2. Each block shown in FIG. 2 represents one or more processes, methods, or subroutines carried in the exemplary method 200. A computer readable media comprising code to perform the acts of the method 200 may also be provided. In one embodiment, FIG. 2 may provide detail on the clustering, compositing, and other operations carried out by the composite critic generator 130 according to an exemplary embodiment. Referring to FIG. 2, the exemplary method 200 may begin at block 210.

At block 210, item interest data (e.g., collaborative rating data) at the collaborative rating database may be formatted. For example, the composite critic generator 130 may format the collaborative rating data 120. In this example, existing interest values (a.k.a. ratings) for each user for each item may be consolidated into a format that facilitates subsequent user clustering 220. It should be appreciated that a variety of formats may be utilized. For example, formats may be full or sparse matrices of rating values. In a full matrix scenario, which may be advantageous if ratings exist for most users for most items, rows of the matrix may represent each user and columns may represent each item. In a sparse matrix scenario, which may be advantageous if there are relatively few ratings for each user-item pair, the matrix may be represented by rows of paired values where each row represents each user and each value pair consists of an item number and a rating value for that item given by that user. Other various embodiments may also be provided.

In one embodiment, sparse user rating data may be provided in a file with a line containing <number of users><number of items><total number of ratings>. This line may be followed by additional lines representing each user as described above for the sparse matrix case. For example, the following may illustrate contents of such a file where there are 5000 users, 10000 items, and 21094 ratings (e.g., item-rating pairs):

$$5000 \; 10000 \; 21094$$

$$30 \; 3 \; 157 \; 3 \; 173 \; 4 \; 175 \; 5 \; 191 \; 2 …$$

$$8 \; 5 \; 28 \; 4 \; 50 \; 5 \; 83 \; 5 …$$

$$1144 \; 4 \; 1202 \; 5 \; 1428 \; 4 …$$

$$…$$

$$30 \; 4 \; 44 \; 3 \; 83 \; 4 \; 313 \; 4 \; 357 \; 1 …$$

In this example, the first user, which may be represented by the line starting “30 3 157 3 173 4” may have rated item 30 a 3, item 157 a 3, item 173 a 4, and so forth. The 5000^{th} user, represented by the final line in the file may have rated item 30 a 4, item 44 a 3, item 83 a 4, and so forth.

Once the item rating data has been appropriately formatted 210, clustering users may be performed, as depicted by block 220. For example, at block 220, a clustering algorithm may be utilized to cluster users into groups of like-minded users. Here, the clustering may be based on an assessment of the similarity of ratings between users and/or may utilize one of a plurality of clustering techniques. In one embodiment, similarity between users may be calculated as: r_{xy}dₛ where r_{xy} may represent a Pearson correlation coefficient, which by way of a non-limiting example, may be expressed as:

$$\frac{s \sum {x}_{i} {y}_{i} - \sum {x}_{i} \sum {y}_{i}}{\sqrt{s \sum {x}_{i}^{2} - {( \sum {x}_{i} )}^{2}} \sqrt{s \sum {y}_{i}^{2} - {( \sum {y}_{i} )}^{2}}} .$$

In the above term, dₛ may represent a logistic function de-rating factor, which by way of a non-limiting example, may be expressed as:

((1+me^{-s/τ})/(1+ne^{-s/τ})).

In the above term, s may represent number of items rated by both user x and user y (e.g., “shared items”), xᵢ and yᵢ represent rating values for shared item i, such that sums are over i=1 to s, and a, m, n, and τ are constants. In one embodiment, exemplary non-limiting values for a, m, n, and τ may be 1, 0, 20, and 2, respectively. It should be appreciated that the logistic function de-rating factor may cause users having few shared items to be scored as less similar to one another than users who have many shared item.

Furthermore, at block 220, once suitable values of user-to-user similarity are found, the clustering algorithm may group users into like-minded clusters. For example, various clustering methods may be utilized. These may include one of many hierarchical and/or partitional techniques, such as k-means, affinity propagation, and/or Markov Clustering. It should be appreciated that a key tradeoff in clustering users to generate composite critics may be finding enough clusters of like-minded individuals that correlate well to most individual users while assuring that there are sufficient user-rating data points in each cluster to provide robust aggregate rating values for most items. For example, in one embodiment, this clustering significance may be investigated empirically by generating various numbers of clusters (k) and assessing the quality of the resulting clusters in terms of (a) “tightness” of resulting clusters, and (b) having enough ratings in each cluster so most items may have meaningful ratings. Metrics may be used to help decide the appropriate number of clusters. Such metrics may include “elbow criterion,” etc. In some embodiments, outlying users may be discarded to avoid degrading composite rating values, which may be determined at block 230.

In another embodiment, clustering may be fuzzy wherein a given user may be included in multiple groups. For example, unlike standard clustering where each user is included in one and only one cluster, this type of clustering may help combat rating sparsity by providing more item ratings in cases where clusters tend to not be very distinct or well separated in rating feature space. Other various embodiments may also be provided.

At block 230, composite critic values may be generated. For example, the composite critic generator 130 may generate critic values by averaging the interest values of all users for each item in each group and substituting a special value for those items having zero or a small number of ratings. What constitutes a small number of ratings may be determined empirically and be dependent on the application. Here, averaging the values may include simple averaging and/or weighted averaging. In some embodiments, weighted averaging may assign greater weight to ratings of users in the cluster who are closest to the centroid or exemplar of the cluster.

In some embodiments, the special value may a global average interest value of all items in the user group. This value may be substituted as the rating value for those items for which there are no ratings from users in the cluster. For instance, in composite critic group A, in the event the average rating for all items is 3.26 on a 1 to 5 scale, the 3.26 rating may be substituted as the rating for all un-rated items. Therefore, for items in the cluster having one or more ratings, simple and/or weighted averaging may be used to generate the composite critic rating. In the event that an item has just one rating, e.g., with the value 5, the 5 rating may be assigned as the composite rating for that item. Similarly, in the event that an item has ratings from two different users in the cluster with values of 1 and 5, the composite rating for that item may be 3, which may be determined by simple averaging: (1+5)/2=3.

In other embodiments, the special value calculated as the global average may be substituted as the rating for un-rated items as discussed above. However, the global average may also be averaged with a per-item average for each item rather than using the per-item average alone. For instance, in the event that just one user in the cluster rated an item 1 and the global average for all items is 3, rather than the composite critic rating value for the item being set to 1 it may be set to 2 by simple averaging: (1+3)/2=2. This may be advantageous in scenarios where total number of ratings for many items in a cluster is low.

In yet other embodiments, the special value substituted as the rating for un-rated items may be the average of the lowest quartile of values for items rated in the cluster. This may be advantageous in situations where total number of ratings for most items in a cluster is high, e.g., to reflect that un-rated items may be disliked since most users in the cluster may be explicitly avoiding consuming it and knew of its existence and/or would have known of its existence had it been a liked item. Thus, the special value may be calculated in other ways consistent with providing a low rating. These may include using the −2 sigma value from the distribution of ratings for the current cluster. Other various embodiments may be provided.

In yet other embodiments, the special value may be generated by an induction method using content-based attributes where average interest values for each item rated by many users may be used as the target independent variable, content-based attributes may be used as the dependent variables during the training phase, and the resulting user model may be used to valuate the special value. Accordingly, this approach may generate missing ratings using content-based processes which may then be used to compensate for rating sparsity in composite critics.

Also in block 230, composite rating attributes may be supplemented by additional attributes derived from the collaborative rating data indicating the number of raters and/or the distribution of ratings applicable to each item in each group. As discussed above, such attributes may further refine rules and/or correlate to individual user preferences. For example, in one embodiment, in the event per-item distributions associated with some composite critic rating values are flat, bi-modal, or tri-modal, the associated ratings may be selected out in resulting rules, e.g., “Bob's item preference corresponds to Critic B's rating if the rating distribution for the item is Normal.”

It should be appreciated that the result of generating composite critic values, as depicted in block 230, may be a series of files containing at least one composite rating value for each item, one file per critic. For example, in one embodiment, in the event there are 15 composite critics (e.g., “clusters” or “segments”), there may be 15 files each containing lines in the following form:

$$1 , 3.800 , 5 , 00270$$

$$2 , 2.500 , 2 , 50050$$

$$3 , 3.757 , 37 , 00261$$

$$4 , 0.000 , 0 , 00000$$

$$5 , 2.143 , 7 , 41310$$

$$…$$

$$10000 , 2.667 , 66 , 13410$$

In this example, each line may include several fields. For example, the first field in each line may represent the item number, and the second field may represent the rating of that item by the composite critic associated with the current file. In some embodiments, the rating may be generated by averaging all ratings made by the users in that cluster that rated the item. The third field may represent total number of users that rated the item that were used to generate the composite rating in field 2. The fourth field may represent the distribution of ratings by the users counted in field 3. Since this example assumes each item was rated on a scale of 1 to 5, the distribution field may represent a histogram indicating what percentage of users rated the item in “bins” of 1, 2, 3, 4, 5, respectively. In other words, the third line of the exemplary file may indicate the following: for item number 3, a composite rating of 3.757 was generated from the ratings of 37 clustered users wherein 2/9 of the users in that cluster rated the item a 3 (e.g., 8 users), 6/9 rated it a 4 (e.g., 25 users), and 1/9 rated it a 5 (e.g., 4 users). It should be appreciated that no one in the cluster rated the item as a 1 or a 2.

At block 240, generated composite critic values may be incorporated into the vectors, e.g., the item vectors 170 as depicted in FIG. 1. In this example, the composite critic values generated by the composite critic generator 130 may be assigned to attributes A1-An for each item in the item vectors 170. In some embodiments, each composite critic rating file may map to one composite critic attribute. For example, in the event the file, as discussed above with respect to block 230, corresponds to composite critic number 1, the A1 attribute for each item vector in 170 would receive the value from the second field in each line in the above file, e.g., attribute A1 for item 10000 would receive a value of 2.667. Other composite critic attributes, corresponding to attributes A2-An, may be similarly valuated using the contents of the files containing the composite rating data for composite critic files 2-n. Other various embodiments may also be realized.

As discussed above, additional processing may be performed on the composite rating values shown above, e.g., before they are used as composite critic rating attribute values. Also, in addition to composite critic rating attributes, there may be other attributes associated with each composite critic, such as one representing the total number of users used to generate the rating attribute for each item (e.g., the third field in each line of the above file), and/or another representing the distribution of user ratings used to generate the composite rating. In this example, for the latter attribute, additional translation the histograms may be utilized in the fourth field to a set of discrete values indicating the type of distribution. These may include “normal,” “bimodal,” “trimodal,” “rising-right,” “rising-left,” “flat,” and/or “other.” For instance, the distribution “50050” shown for item number 2 (e.g., indicating everyone in the cluster rated item number 2 a 1 or a 4 in equal proportions) may translate to a distribution attribute value of “bimodal” for the attribute associated with item 2 for critic number 1. Other various embodiments may also be considered.

Referring back to FIG. 1, once the content-based attributes are extracted by the content attribute extractor 140 and composite critic attributes generated by the composite critic generator 130, both sets of attributes may be incorporated in item vectors 170. As described above, user models may then be created by the induction/recommendation engine 180 for storage at the user models database 190. The induction/recommendation engine 180 may utilize a decision tree, artificial neural network, support vector machine, regression tree, decision tree with linear models in leaves, and/or other machine learning induction mechanism or statistical method. Ultimately, the induction/recommendation engine 180 may employ the user models for recommending or filtering new items to/from users by receiving vectors representing new items and generating a classification value or predicted rating as output and presenting appropriate recommendations to users at user terminals 110(a)-110(n) via a graphical user interface or other similar interface.

In an embodiment, the induction/recommendation engine 180 may construct decision trees with linear models in leaves, e.g., using Cubist software from RuleQuest Research. In this example, a “*.names” file may be provided to define the attributes. For instance, for a movie recommender, a file called “movies.names” may include the following lines:

$$rating . \\ movie\_id \text{:} label . \\ rating \text{:} continuous . \\ composite\_critic 1 \_rating \text{:} continuous . \\ composite\_critic 2 \_rating \text{:} continuous . \\ …$$

$$composite\_criticn \_rating \text{:} continuous . \\ rating\_date \text{:} date . \\ release\_year \text{:} continuous . \\ genre\_action \text{:} 0 , 1.$$

$$genre\_animation \text{:} 0 , 1.$$

$$genre\_comedy \text{:} 0 , 1.$$

$$…$$

$$advisory\_language \text{:} 0 , 1.$$

$$advisory\_sexuality \text{:} 0 , 1.$$

$$advisory\_violence \text{:} 0 , 1.$$

$$…$$

$$last\_content \_attribute \text{:} 0 , 1.$$

The file may define the meaning of all attributes in item vectors 170. For example, the field “rating.” may represent the dependent variable being predicted. More specifically, the field “rating.” may be the rating given by the viewer to the movie represented by the vector. The field “movieid: label.” may represent that a movie ID may appear in the first position of each item vector. Assigning this field the data type “label” may indicate that it is not used for predicting ratings. The field “rating: continuous.” may represent that a continuously-valued rating value may appear in the second position of item vectors 170 when training/inducing the decision tree for each viewer. It should be appreciated that these first two attributes may not be depicted in the item vectors 170. The fields “composite critic 1 rating: continuous.” through “composite_criticn_rating: continuous.” may represent the composite critic attributes A1-An in the item vectors 170. The fields “rating date: date.” through “last content attribute: 0, 1.” correspond to content attributes B1-Bn in the item vectors 170, which may represent content-based attributes indicative of the content of the items. The data types “date,” “continuous,” and “0, 1” may represent the kinds of values expected by the induction/recommendation engine 180 for the associated attribute. The type “0, 1” may represent that the attribute is Boolean. Other various embodiments may also be provided.

Given this definition of attributes above, predictive models consisting of decision trees with linear models in leaves may be generated, e.g., by submitting training examples to Cubist. These examples may take the form of a *.data file (or other similar file) containing vectors of valuated attributes for each rated item along with a corresponding actual rating value. Referring back to the movie recommender example, a file called “viewer. data” may be generated on the fly for a viewer by retrieving a sample of movie ratings made by that viewer and the item vectors 170 corresponding to those movies. For instance, consider a viewer having previously rated movies corresponding to the following <movie ID>,<rating> pairs:

$$12 , 3$$

$$18 , 5$$

$$38 , 4$$

$$112 , 3$$

$$…$$

$$9286 , 2$$

Here, the item vectors for movies 12, 18, 38, 112, . . . , 9286 may be retrieved from storage (not shown) for the item vector 170 and appended to these pairs to create a viewer.data file of the following form:

$$12 , 3 , 4.124 , 2.347 , … , 3.250 , 06 \text{-} 04 \text{-} 01 , 1985 , … , 0$$

$$18 , 5 , 3.766 , 3.000 , … , 4.029 , 06 \text{-} 10 \text{-} 24 , 1999 , … , 1$$

$$38 , 4 , 1.695 , 3.452 , … , 3.980 , 07 \text{-} 06 \text{-} 07 , 2006 , … , 1$$

$$112 , 3 , 3.288 , 4.583 , … , 2.788 , 05 \text{-} 12 \text{-} 25 , 1999 , … , 1$$

$$…$$

$$9286 , 2 , 4.405 , 2.666 , … , 4.100 , 08 \text{-} 07 \text{-} 22 , 2008 , … , 0$$

Here, the third through final fields of each line may contain composite critic and content attributes for the movie from the item vector 170 (A1, A2, . . . , An, B1, B2, . . . Bn) indicated by the ID in the first field.

Accordingly, Cubist (or other similar software) may then build a user model using this file that is capable of predicting ratings for unseen movies based on composite critic and content-based attributes for the associated viewer. By doing this for all viewers, and storing the user models locally or centrally (e.g., at the user models database 190), predictions may be made on-demand for all viewers by submitting item vectors, minus the rating attribute, to Cubist. It should be appreciated that similar models may be built to recommend and/or filter items as appropriate to many other applications.

It should also be appreciated that exemplary embodiments may support one or more additional security and/or business functions/features. It should also be appreciated that while exemplary embodiments are described as being implemented over wired networks and systems, other various embodiments may also be provided. For example, registration may be implemented over wireless networks or systems. Whether wired or wireless, the network and/or system may be a local area network (LAN), wide area network (WAN), or any other network configuration. Additionally, various communication interfaces may be used. These may include an integrated services digital network (ISDN) card or a modem to provide a data communication connection. In another embodiment, the communication interface may be a local area network (LAN) card to provide a data communication connection to a compatible LAN. Wireless links (e.g., microwave, radio, etc.) may also be implemented. In any such implementation, the communication interface may send and receive electrical, electromagnetic, and/or optical signals that carry digital data streams representing various types of information.

In some embodiments, the wireline network/system may include long-range optical data communications, local area network based protocols, wide area networks, and/or other similar applications. In other embodiments, wireless broadband connection may include long-range wireless radio, local area wireless network such as Wi-Fi (802.11xx) based protocols, wireless wide area network such as Code Division Multiple Access (CDMA)—Evolution Data Only/Optimized (EVDO), Global System for Mobile-Communications (GSM)—High Speed Packet Access (HSPA), WiMax, infrared, voice command, Bluetooth™, Long Term Evolution (LTE), and/or other similar applications. In yet another embodiment, the network with which communications are made may include the Internet or World Wide Web. Other networks may also be utilized for connecting each of the various devices, systems and/or servers.

The description above describes network elements, computers, and components of systems of and methods for supplementing content-based attributes with collaborative rating attributes for recommending or filtering items that may include one or more modules. As used herein, the term “module” may be understood to refer to non-transitory executable software, firmware, hardware, and various combinations thereof. Modules however are not to be interpreted as software which is not implemented on hardware, firmware, or recorded on a processor readable recordable storage medium (i.e., modules are not software per se). It is noted that the modules are exemplary. The modules may be combined, integrated, separated, and duplicated to support various applications. Also, a function described herein as being performed at a particular module may be performed at one or more other modules and by one or more other devices instead of or in addition to the function performed at the particular module. Further, the modules may be implemented across multiple devices and other components local or remote to one another. Additionally, the modules may be moved from one device and added to another device, and may be included in both devices.

By performing the various features and functions as discussed above, the systems and methods described may allow comprehensive and efficient provision of personal recommendations for enhancing business, marketing, advertisements, and/or other related products/services.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

1. A method for recommending or filtering items, the method comprising:
obtaining item interest data from users;
clustering the users into groups of users based on the interest data;
generating composite rating attribute values for each item, wherein each attribute value represents an aggregation of the interest data for the item for one or more of the groups of users;
creating one or more user preference models using the composite rating attribute values in conjunction with content-based attributes; and
at least one of recommending items to users and filtering items from users based on the user preference models.

2. The method of claim 1, wherein the items are at least one of television programs, movies, music, books, documents, products, services, e-mails, and advertisements.

3. The method of claim 1, wherein the item interest data are represented as binary preference values.

4. The method of claim 1, wherein the item interest data are represented as a multi-valued range of ratings.

5. The method of claim 1, wherein obtaining item interest data comprises obtaining data from a plurality of users whose item interest data are gathered over time via a collaborative-filtering system, wherein the item interest data are gathered implicitly, explicitly, or a combination thereof.

6. The method of claim 1, wherein obtaining item interest data comprises obtaining item interest data from users selected for having differing sensibilities, wherein these users serve as a de facto groups of users.

7. The method of claim 1, wherein clustering the users into groups comprises at least one of a hierarchical and partitional process based on an assessment of similarity of ratings between users.

8. The method of claim 7, wherein the similarity is calculated as: r_{xy}dₛ where r_{xy} is the correlation coefficient,
$$\frac{s \sum {x}_{i} {y}_{i} - \sum {x}_{i} \sum {y}_{i}}{\sqrt{s \sum {x}_{i}^{2} - {( \sum {x}_{i} )}^{2}} \sqrt{s \sum {y}_{i}^{2} - {( \sum {y}_{i} )}^{2}}} ,$$
and dₛ is a logistic function de-rating factor, a((1+me^{-s/τ})/(1+ne^{-s/τ})), where s is the number of items rated by both user x and user y, xᵢ and yᵢ are the rating values for shared item i, sums are over i=1 to s, and a, m, n, and τ are constants.

9. The method of claim 1, wherein clustering the users into groups is fuzzy such that a user may be included in multiple groups.

10. The method of claim 1, wherein generating a composite rating attribute value comprises averaging interest values of all the users in a given group and substituting a special value for those items having zero or a small number of ratings.

11. The method of claim 10, wherein the special value is the global average interest value of all items in the group.

12. The method of claim 10, wherein the special value is at least one of:
the global average interest value of all items in the user group for items having zero ratings, and
the global average interest value averaged in with the existing item ratings for items having one or more ratings.

13. The method of claim 10, wherein the special value is equal to the average of the lowest quartile of values for items over the entire group.

14. The method of claim 10, wherein the special value is generated by an induction process using content-based attributes alone wherein the average interest values for each item rated by users are used as target independent variables and content-based attributes are used as dependent variables during a training phase, and the resulting user preference model is used to valuate the special value.

15. The method of claim 1, wherein generating composite rating attribute values further comprises generating additional attributes that indicate at least one of:
the total number of raters used to generate each composite rating attribute value for each item in each group, and
the distribution of ratings used to generate each composite rating attribute value for each item in each group.

16. The method of claim 1, wherein creating user preference models utilizes at least one of a decision tree, artificial neural network, support vector machine, regression tree, decision tree with linear models in leaves, machine learning induction mechanism, and statistical process.

17. The method of claim 1, wherein the at least one of recommending and filtering comprises:
submitting vectors for new items having composite rating attribute values and content attribute values to the previously-generated user model, and
receiving a classification value or predicted rating as output.

18. A computer readable medium comprising code to perform the acts of the method of claim 1.

19. A system for recommending or filtering items, the system comprising:
at least one processor for obtaining item interest data from users, clustering the users into groups of users based on the item interest data, generating composite rating attribute values for each item wherein each attribute value represents an aggregation of the interest data for the item for one or more of the groups of users, creating one or more user preference models using the composite rating attribute values in conjunction with content-based attributes, and at least one of recommending items to users and filtering items from users based on the user preference models.

20. The system of claim 19, wherein the items are at least one of television programs, movies, music, books, documents, products, services, e-mails, and advertisements.

21. The system of claim 19, wherein the item interest data are represented as binary preference values.

22. The system of claim 19, wherein the item interest data are represented as a multi-valued range of ratings.

23. The system of claim 19, wherein obtaining item interest data comprises obtaining data from a plurality of users whose item interest data are gathered over time via a collaborative-filtering system, wherein the item interest data are gathered implicitly, explicitly, or a combination thereof.

24. The system of claim 19, wherein obtaining item interest data comprises obtaining item interest data from users selected for having differing sensibilities, wherein these users serve as de facto groups of users

25. The system of claim 19, wherein clustering the users into groups comprises at least one of a hierarchical and partitional process based on an assessment of similarity of ratings between users.

26. The system of claim 25, wherein the similarity is calculated as: r_{xy}dₛ where r_{xy} is the correlation coefficient,
$$\frac{s \sum {x}_{i} {y}_{i} - \sum {x}_{i} \sum {y}_{i}}{\sqrt{s \sum {x}_{i}^{2} - {( \sum {x}_{i} )}^{2}} \sqrt{s \sum {y}_{i}^{2} - {( \sum {y}_{i} )}^{2}}} ,$$
and dₛ is a logistic function de-rating factor, a((1+me^{-s/τ})/(1+ne^{-s/τ})), where s is the number of items rated by both user x and user y, xᵢ and yᵢ are the rating values for shared item i, sums are over i=1 to s, and a, m, n, and τ are constants.

27. The system of claim 19, wherein clustering the users into groups is fuzzy such that a user may be included in multiple groups.

28. The system of claim 19, wherein generating a composite rating attribute value comprises averaging interest values of all the users in each group and substituting a special value for those items having zero or a small number of ratings.

29. The system of claim 28, wherein the special value is the global average interest value of all items in the group.

30. The system of claim 28, wherein the special value is at least one of:
the global average interest value of all items in the user group for items having zero ratings, and
the global average interest value averaged in with the existing item ratings for items having one or more ratings.

31. The system of claim 28, wherein the special value is equal to the average of the lowest quartile of values for items over the entire group.

32. The system of claim 28, wherein the special value is generated by an induction process using content-based attributes alone wherein the average interest values for each item rated by users are used as target independent variables and content-based attributes are used as dependent variables during a training phase, and the resulting user preference model is used to valuate the special value.

33. The system of claim 19, wherein generating composite rating attribute values further comprises generating additional attributes that indicate at least one of:
the total number of raters used to generate each composite rating attribute value for each item in each group, and
the distribution of ratings used to generate each composite rating attribute value for each item in each group.

34. The system of claim 19, wherein creating user preference models utilizes at least one of a decision tree, artificial neural network, support vector machine, regression tree, decision tree with linear models in leaves, machine learning induction mechanism, and statistical process.

35. The system of claim 19, wherein the at least one of recommending and filtering comprises:
submitting vectors for new items having composite rating attribute values and content attribute values to the previously-generated user model, and
receiving a classification value or predicted rating as output.

36. A method for recommending or filtering items, the method comprising:
receiving collaborative rating data about items;
generating composite critic attributes based the collaborative rating data;
receiving item content data;
extracting content attributes based on the item content data;
compositing the generated composite critic attributes and the extracted content attributes into item vectors;
generating user preference models based on the composited attributes in the item vectors; and
using the user preference models to at least one of:
recommend new items to one or more users, and
classify, filter, or rate items in one or more learning or personalization applications.
